(19) United States
(12) Patent Application Publication
(10) Pub. No.: US 2016/0050545 A1
(43) Pub. Date: Feb. 18, 2016

(54) IDENTIFYING DOWNLINK USER PACKETS

(71) Applicant: NOKIA SOLUTIONS AND NETWORKS OY, Karaportti 3 (FI)

(72) Inventors: Devaki CHANDRAMOULI, Plano, TX (US); Rainer LIEBHART, Munich (DE); Curt WONG, Bellevue, WA (US); Peter LEIS, Penzberg (DE)

(21) Appl. No.: 14/782,902

(22) PCT Filed: Apr. 8, 2014
(86) PCT No.: PCT/EP2014/056986

§ 371 Date: Oct. 7, 2015

Related U.S. Application Data
(60) Provisional application No. 61/817,653, filed on Apr. 30, 2013.

(51) Int. Cl. H04W 4/08

(52) U.S. Cl. CPC H04W 4/08; H04W 80/04

(57) ABSTRACT

A method and apparatus can be configured to transmit, by a first user equipment, a first communication. The method can also receive, by the first user equipment, a group communication. The group communication is directed to a group. The group comprises the first user equipment and a second user equipment. The group communication comprises the first communication. The group communication also comprises an identifier that identifies the first communication of the group communication as originating from the first user equipment. The method can also identify, by the first user equipment, that the first communication of the group communication originates from the first user equipment based on the identifier. The method can also ignore the first communication of the group communication.

### BACKGROUND

1. Field

Embodiments of the invention relate to identifying certain downlink user packets that are transmitted between group members.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method can comprise transmitting, by a first user equipment, a first communication. The method can also include receiving, by the first user equipment, a group communication. The group communication is directed to a group. The group comprises the first user equipment and a second user equipment. The group communication comprises the first communication. The group communication also comprises an identifier that identifies the first communication of the group communication as originating from the first user equipment. The method also includes identifying, by the first user equipment, that the first communication of the group communication originates from the first user equipment based on the identifier. The method also includes ignoring the first communication of the group communication.

In the method of the first embodiment, the group communication also comprises a second communication, and the second communication originates from the second user equipment.

In the method of the first embodiment, the identifier corresponds to an internet protocol address of the first user equipment.

In the method of the first embodiment, the group communication is delivered using Real Time Protocol, and the identifier is delivered in a Synchronization Source Identifier field.

In the method of the first embodiment, the group communication is delivered using Real Time Protocol, and the identifier is delivered in an optional header extension field.

In the method of the first embodiment, the identifier corresponds to a negotiated identifier, and the negotiated identifier is the result of negotiations between the first user equipment and at least one of an application server and a gateway.

According to a second embodiment, an apparatus can comprise at least one processor. The apparatus can also include at least one memory including computer program code, the at least one memory and the computer program code configured, with the at least one processor, to cause the apparatus at least to transmit, by a first user equipment, a first communication. The apparatus can also receive, by the first user equipment, a group communication. The group communication can be directed a group. The group can comprise the first user equipment and a second user equipment. The group communication can comprise the first communication. The group communication also comprises an identifier that identifies the first communication of the group communication as originating from the first user equipment. The apparatus can also identify, by the first user equipment, that the first communication of the group communication originates from the first user equipment based on the identifier. The apparatus can also ignore the first communication of the group communication.

In the apparatus of the second embodiment, the group communication also comprises a second communication, and the second communication originates from the second user equipment.

In the apparatus of the second embodiment, the identifier corresponds to an internet protocol address of the first user equipment.

In the apparatus of the second embodiment, the group communication is delivered using Real Time Protocol, and the identifier is delivered in a Synchronization Source identifier field.

In the apparatus of the second embodiment, the group communication is delivered using Real Time Protocol, and the identifier is delivered in an optional header extension field.

In the apparatus of the second embodiment, the identifier corresponds to a negotiated identifier, and the negotiated identifier is the result of negotiations between the first user equipment and at least one of an application server and a gateway.

According to a third embodiment, a computer program product can be embodied on a computer readable medium. The computer program product can be configured to control a processor to perform a process, comprising transmitting, by a first user equipment, a first communication. The process can include receiving, by the first user equipment, a group communication. The group communication is directed a group. The group comprises the first user equipment and a second user equipment. The group communication comprises the first communication, and the group communication also comprises an identifier that identifies the first communication of the group communication as originating from the first user equipment. The process can include identifying, by the first user equipment, that the first communication of the group communication originates from the first user equipment based on the identifier. The process can include ignoring the first communication of the group communication.

According to a fourth embodiment, a method can comprising receiving a first communication. The first communication originates from a first user equipment. The method can also include transmitting a group communication. The group communication is directed to a group. The group comprises the first user equipment and a second user equipment. The group communication comprises the first communication and an identifier that identifies the first communication of the group communication as originating from the first user equipment.

In the method of the fourth embodiment, the receiving and the transmitting are performed by at least one of an application server and a gateway.

In the method of the fourth embodiment, the group communication also comprises a second communication, and the second communication originates from the second user equipment.

In the method of the fourth embodiment, the identifier corresponds to an internet protocol address of the first user equipment.

In the method of the fourth embodiment, the group communication is delivered using Real Time Protocol, and the identifier is delivered in a Synchronization Source identifier field.

In the method of the fourth embodiment, the group communication is delivered using Real Time Protocol, and the identifier is delivered in an optional header extension field.

According to a fifth embodiment, an apparatus can comprise at least one processor. The apparatus can also include at least one memory including computer program code. The at least one memory and the computer program code configured, with the at least one processor, to cause the apparatus at least to receive a first communication. The first communication originates from a first user equipment. The apparatus can also transmit a group communication. The group communication is directed to a group. The group comprises the first user equipment and a second user equipment. The group communication comprises the first communication and an identifier that identifies the first communication of the group communication as originating from the first user equipment.

In the apparatus of the fifth embodiment, the receiving and the transmitting are performed by at least one of an application server and a gateway.

In the apparatus of the fifth embodiment, the group communication also comprises a second communication, and the second communication originates from the second user equipment.

In the apparatus of the fifth embodiment, the identifier corresponds to an internet protocol address of the first user equipment.

In the apparatus of the fifth embodiment, the group communication is delivered using Real Time Protocol, and the identifier is delivered in a Synchronization Source identifier field.

In the apparatus of the fifth embodiment, the group communication is delivered using Real Time Protocol, and the identifier is delivered in an optional header extension field.

According to a sixth embodiment, a computer program product can be embodied on a computer readable medium. The computer program product can be configured to control a processor to perform a process comprising receiving a first communication. The first communication originates from a first user equipment. The process can also include transmitting a group communication. The group communication is directed to a group, the group comprises the first user equipment and a second user equipment, the group communication comprises the first communication and an identifier that identifies the first communication of the group communication as originating from the first user equipment.

According to a seventh embodiment, a method can comprise transmitting, by a first user equipment, a first communication via a dedicated bearer. The dedicated bearer is established once the first user equipment is authorized to transmit the first communication. The first communication is included in a first group communication. The first group communication is directed to a group via a broadcast bearer. The group comprises the first user equipment and a second user equipment. The group communication also comprises a second communication transmitted by the second user equipment. The method can also include receiving, by the first user equipment, a second group communication via the dedicated bearer. The second group communication comprises the second communication. The second group communication does not include the first communication. The first user equipment ignores the first group communication directed to the group via the broadcast bearer while the dedicated bearer is established. The dedicated bearer is deactivated after the broadcast bearer has transmitted all of the first communication of the first group communication to the second user equipment. The method can also include receiving, by the first user equipment, the first group communication via the separate broadcast bearer once the dedicated bearer is deactivated.

According to an eighth embodiment, a method can comprise receiving a first communication via a dedicated bearer. The dedicated bearer is established once a first user equipment is authorized to transmit the first communication. The method can also include transmitting a first group communication via a separate broadcast bearer. The first group communication is directed to a group, the group comprises the first user equipment and a second user equipment. The first group communication comprises the first communication, and the group communication also comprises a second communication transmitted by a second user equipment. The method can also include transmitting a second group communication via the dedicated bearer. The second group communication comprises the second communication. The second group communication does not include the first communication. The dedicated bearer is deactivated after the separate broadcast bearer has transmitted all of the first communication of the first group communication to the second user equipment.

### BRIEF DESCRIPTION OF THE DRAWINGS

For proper understanding of the invention, reference should be made to the accompanying drawings, wherein:

FIG. 1 illustrates a multimedia-broadcast/multicast-service (MBMS) reference architecture.

FIG. 2 illustrates a problem using MBMS broadcast in accordance with the previous approaches.

FIG. 3 illustrates an MBMS broadcast in accordance with one embodiment.

FIG. 4 illustrates an MBMS broadcast in accordance with another embodiment.

FIG. 5 illustrates an MBMS broadcast in accordance with another embodiment.

FIG. 6 illustrates a logic flow diagram of a method according to one embodiment.

FIG. 7 illustrates a logic flow diagram of a method according to another embodiment.

FIG. 8 illustrates an apparatus according to an embodiment.

FIG. 9 illustrates an apparatus according to another embodiment.

FIG. 10 illustrates an apparatus according to another embodiment.

### DETAILED DESCRIPTION

Evolved packet system (EPS) technologies are generally considered to be the successor technologies of General Packet Radio Service (GPRS) technologies. EPS provides a new radio interface as well as new packet core network functions for broadband wireless data access. Such EPS core network functions are performed in conjunction with Mobility Management Entities (MME), Packet Data Network Gateways (P-GW), and Serving Gateways (S-GW).

A common packet domain core network can be used in conjunction with radio access networks, such as Evolved Universal Terrestrial Radio Access Networks (E-UTRAN), GSM EDGE Radio Access Networks (GERAN), and UMTS Terrestrial Radio Access Networks (UTRAN), for example.

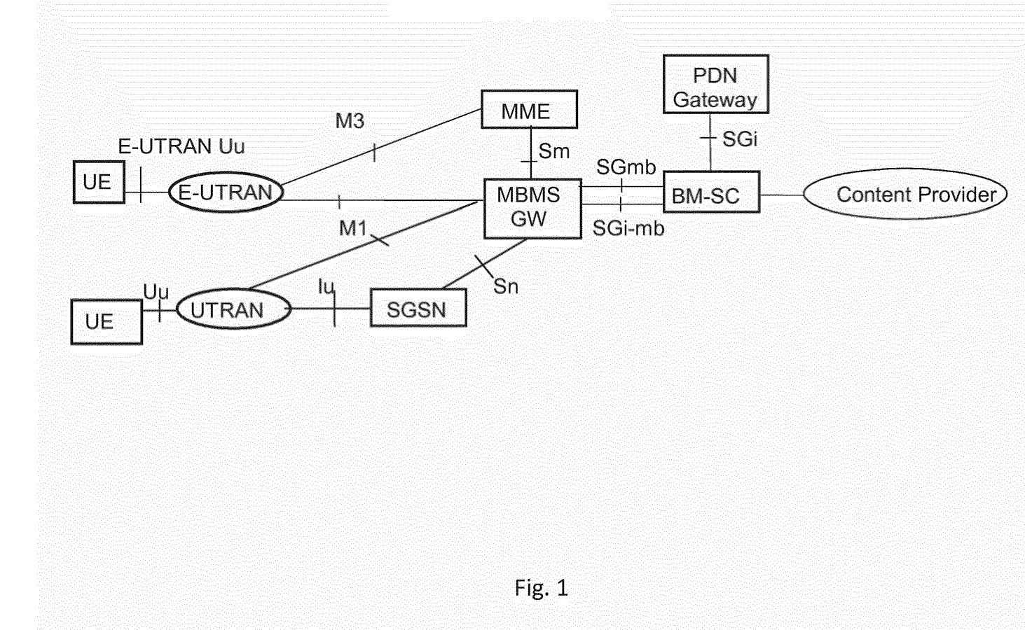

FIG. 1 illustrates a multimedia-broadcast/multicast-service (MBMS) reference architecture. The reference architecture of FIG. 1 can be configured in accordance with 3rd Generation Partnership Project (3GPP) specifications. The MBMS reference architecture can be for an evolved packet system that uses E-UTRAN and UTRAN. In the previous approaches, the MBMS architectures generally support only broadcast services.

It is generally desirable for 3GPP technologies to enable group communication for accomplishing public-safety purposes. 3GPP technologies can be directed to providing an EPS that serves as a mechanism for providing group communication. The group communication can comprise communication between group members within the EPS. 3GPP technologies can allow transmissions/receptions to occur among all of the user equipment (UE) of members of a Group Communication Service Enabler (GCSE) group, and the transmissions/receptions can be limited to the UE of these members of the GCSE group. 3GPP technologies can also provide an ability for the EPS that allows authorized UEs to dynamically participate in communications within different groups, as needed by the authorized UEs.

In view of the above, in one embodiment, an EPS enables group communication among UEs of members of a group, and the UE of the different group members receive group communication using a downlink (DL) channel, as described in more detail below. At the same time, in one embodiment, at least one UE of the group of UEs can express its interest to become a “talker” and thus transmit communication via an uplink channel to a destination. The communication can then be included in group communication and thus be broadcasted again as the group communication over a DL channel. The group communication over the DL channel can reach the UEs of the different members of the relevant group (including the talking UE). The communication can comprise different media such as audio, pictures, text, and video, for example.

MBMS (broadcast) bearers can be used for group communication. Specifically, MBMS bearers are services that can be used to deliver DL communications to the UEs of a group, as described above. As described above, group communication received on the DL by the UEs of the group can include communication that was transmitted by a particular UE (the talker) of the group. As such, the group communication can be relayed from the talking UE to receiving UEs of the same group (listeners).

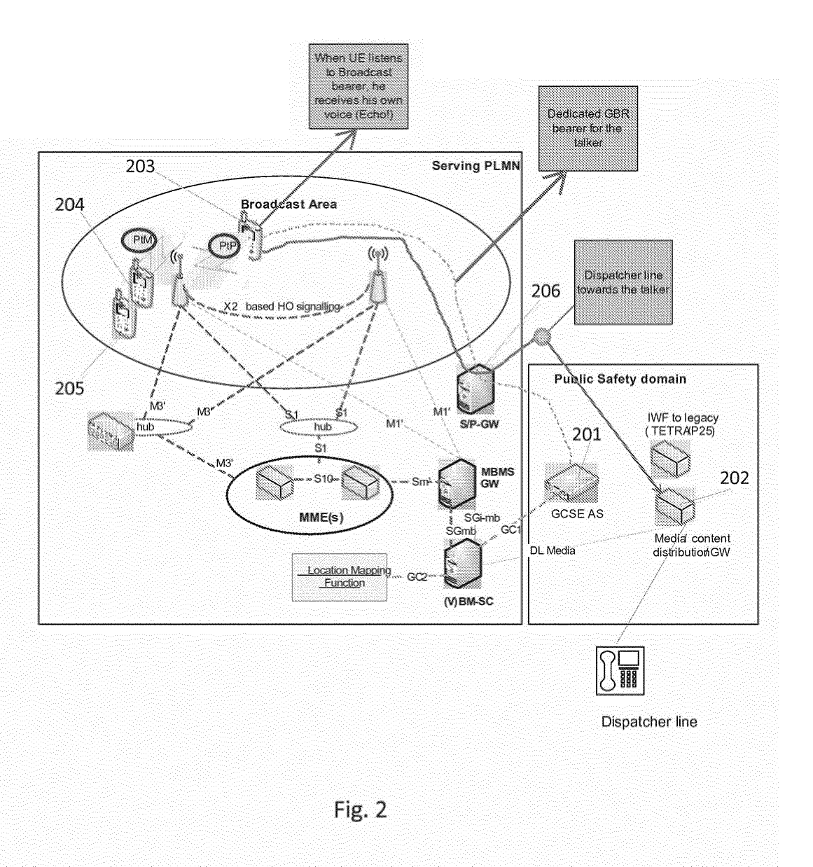

FIG. 2 illustrates a problem using MBMS broadcast in accordance with the previous approaches. As described above, talking UE 203 can transmit communication (via UL) to Group Communication Service Enabler (GCSE) Application Server (AS) 201. GCSE AS 201 can then transmit group communication (via DL) to group UEs (203-205). The group communication can include the communication earlier transmitted by talking UE 203. As a result, talking UE 203 can hear its own voice/transmitted-communication. If talking UE 203 listens to its own voice, a user of talking UE 203 can perceive an echoing effect. These echoing effects can be undesirable in many circumstances. However, in other circumstances, talking UE 203 may wish to receive its own voice/transmission for recording purposes or for quality-monitoring purposes.

In view of the above, certain embodiments of the present invention can accommodate both: (1) users that prefer to avoid receiving their own voice/communication, and (2) users that prefer to receive their own voice/communication.

To accommodate users that prefer to avoid receiving their own voice/communication, one embodiment of the present invention allows a talking UE to avoid receiving its own communication. This embodiment enables a talking UE to identify the communication that originates from itself. Specifically, when the talking UE receives group communication via the DL, the talking UE can identify which DL packets originate from the talking UE itself and can then ignore these packets. As such, in one embodiment, the talking UE can avoid hearing its own voice, avoid seeing its own video, avoid receiving its own pictures, and/or avoid receiving its own texts.

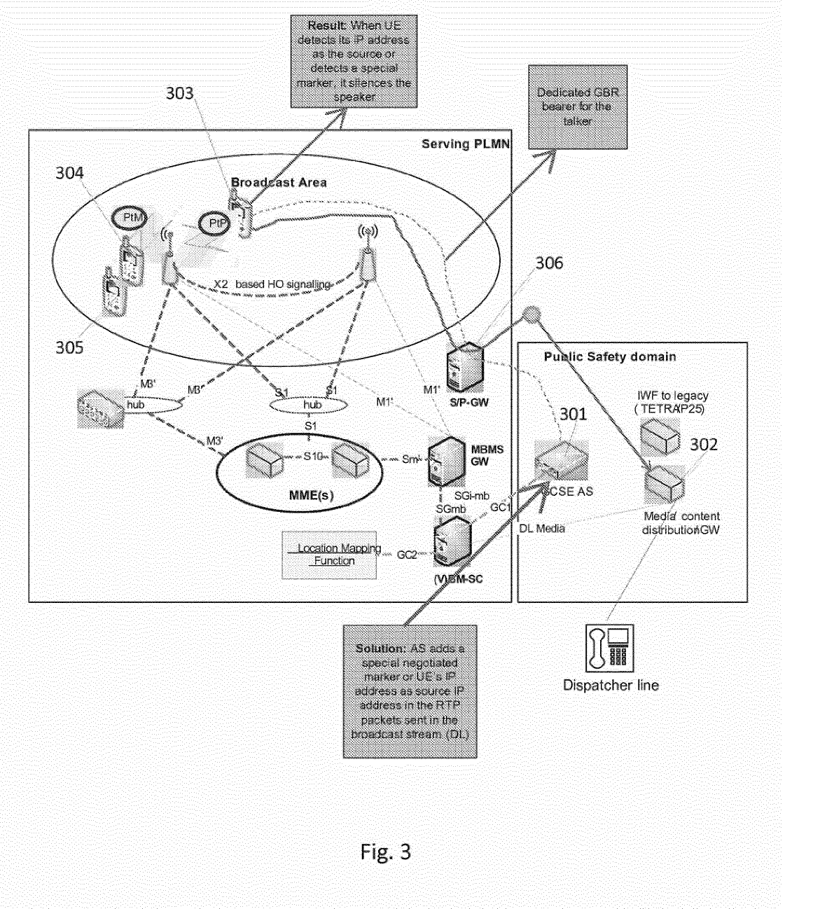

FIG. 3 illustrates an MBMS broadcast in accordance with one embodiment. In this embodiment, UE 303 can request a Group Communication Service Enabler (GCSE) Application Server (AS) 301 for the floor (UE 303 can request to become a talking UE). Once UE 303 is authorized to be a talking UE, GCSE AS indicates to Media Gateway 302 that it can start receiving the communication transmitted by talking UE 303 and insert a corresponding identification in the media stream in the DL direction such that UE 303 can identify the DL media that originates from itself, as described above. In other words, Media Gateway 302 can be the destination to which talking UE 303 transmits communication media to. The described embodiments and functions of the invention can be used with GCSE AS and/or media gateways and are not limited to being used with only GCSE AS. For example, GCSE AS 301 can determine the Internet Protocol (IP) address of talking UE 303 (the source) of the communication. Next, GCSE AS 301 can indicate to Media Gateway 302 to include the Internet Protocol (IP) address of talking UE 303 as part of the media for the group communication to be transmitted to the group UEs (303-305) via the DL. The source IP address can serve as an identifier that identifies communication (within the group communication) as originating from talking UE 303. Such transmissions from Media Gateway 302 can be performed via user-plane-packets signaling, for example. Once talking UE 303 receives the group communication and receives its own IP address (the source IP address being transmitted along with the group communication), talking UE 303 can ascertain that its own IP address corresponds to the transmitted source IP address, and thus talking UE 303 can determine that the received group communication corresponds to the communication that originated from talking UE 303 itself.

In other words, because Media Gateway 302 transmits a source IP address with the transmitted group communication, talking UE 301 (that receives the group communication) is able to determine which data packets (of the group communication) originated from talking UE 301 itself. This embodiment can be used as long as the source IP address is not changed on its way from the GCSE AS/Media GW (301 and 302) to talking UE 303.

One embodiment can use all kinds of data packets, such as internet protocol packets, for example. In this embodiment, GCSE AS 301 and/or Media GW 302 have access to the IP address of talking UE 303. The IP address is not modified by network address translation (NAT) in the intermediate nodes, such as P-GW, between talking UE 303 and GCSE AS/Media Gateway (301 and 302). GCSE AS/Media GW (301 and 302) receive the IP address of talking UE 303, from talking UE 303 itself, via application layer signaling or via direct transmission in an uplink-user-plane packet. After GCSE AS/Media GW (301 and 302) receive the group communication transmitted from talking UE 303 in the UL, GCSE AS/Media GW (301 and 302) can then transmit the IP address of talking UE 303 as a source address associated with the group communication sent via IP packets in the DL to the group UE members (303-305). In this embodiment, intermediate network elements do not modify the source IP address, and S/P-GW 306 does not consider the IP packets as packets that are spoofed based on the source IP addresses. As described above, talking UE 303 can receive its own IP address (as a source address) within the DL IP packets of the group communication, and talking UE 303 can thus ascertain that these DL IP packets originated from talking UE 303 itself. Talking UE 303 can thus ignore the IP packets from itself and thus avoid hearing its own voice.

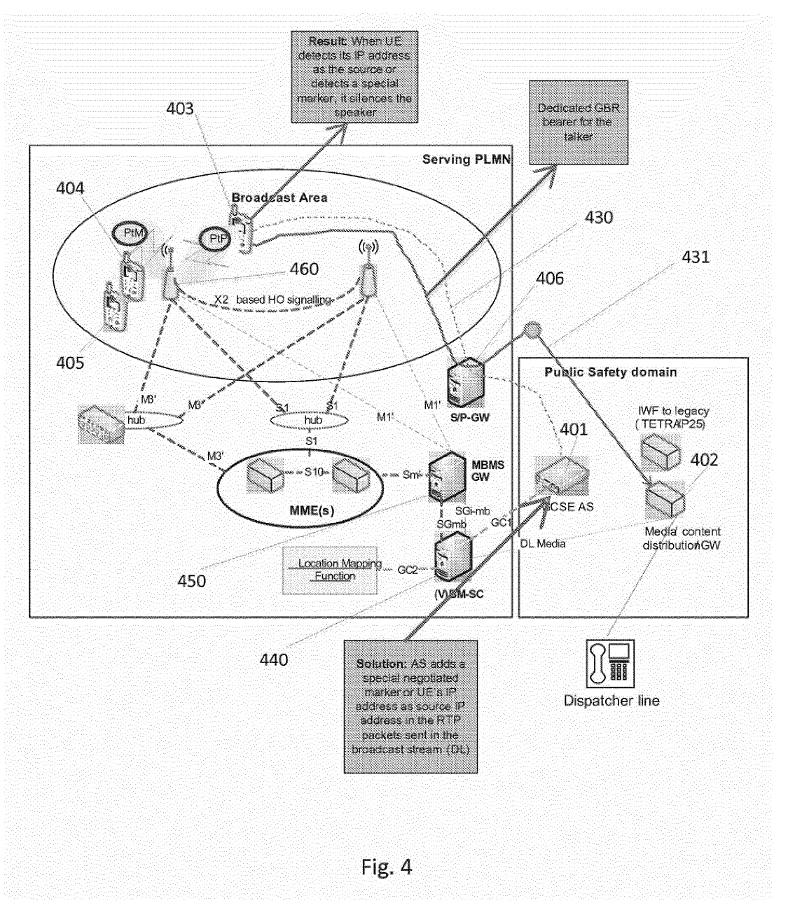

FIG. 4 illustrates an MBMS broadcast in accordance with another embodiment. In this embodiment, a transport data protocol that is used to provide the group communication can also include a source-identification field, or another field capable of transmitting an identifier that uniquely identifies the source of the group communication (such as a talking UE, for example). If Real Time Protocol (RTP) is used as the transport data protocol for delivering the group communication, a field capable of transmitting the unique identifier can be the Synchronization Source (SSRC) identifier field. If RTP is used as the transport data protocol, an optional header extension field can also be used as a unique identifier.

As long as GCSE AS/Media GW (401 and 402) do not change the SSRC identifier in the RTP header, talking UE 403 can use the SSRC identifier to identify that talking UE 403 is itself the originator of the RTP packets. On the other hand, if the SSRC identifier cannot be guaranteed to be unique amongst all possible source UEs (all the UEs that can possibly talk), then the following alternative identifiers can be used if RTP is used as the transport data protocol.

As one alternative identifier, one embodiment can use an optional RTP header extension field to identify the source of portions of the group communication (sent to the group UEs). For example, an optional RTP header extension field can indicate the source of portions of the group communication (for example, by identifying the talking UE's IP address, Mobile Station International Subscriber Directory Number (MSISDN), and/or Session Initiation Protocol (SIP) Uniform Resource Identifier (URI)). As another alternative identifier, GCSE AS/Media GW 401 can negotiate with talking UE 403 via application layer signaling to determine a source identifier. The negotiated source identifier can be determined based on a global Group ID, a UE-specific ID, a random number, an MSISDN, a SIP URI, and/or an IP address. Talking UE 403 can provide this information in the RTP header, in the SSRC field, and/or in an optional header extension, for example. Talking UE 403 can also generate a random value to fill the SSRC field, as described in Request for Comments (RFC) 3550. This embodiment can ensure that each possible talking UE is associated with a unique identifier.

Referring again to FIG. 4, in one embodiment, UE 403 requests GCSE AS/Media Gateway (401 and 402) for the floor (UE 403 requests to become a talking UE). GCSE AS/Media GW (401 and 402) and talking UE 403 can negotiate a UE specific source identifier.

As described above, talking UE 403 can provide this source identifier in the UL packets, in an SSRC field, or in an optional header extension field. GCSE AS 401 can also pre-establish a dedicated guaranteed bitrate (GBR) bearer for the UL communication. Communication (which is included within group communication) is transmitted from talking UE 403 to the GCSE AS 401 via the UL. GCSE AS 401 can also establish MBMS bearer(s) for DL streaming from the GCSE AS 401 to the group members (403-405). The communication transmitted via the DL streaming is transmitted from the GCSE AS 401 to the group UEs (403-405). As such, UE 403 can listen to both MBMS broadcast bearer(s) and dedicated GBR bearers. Signaling connection 430 is represented by a dotted line between UE 403 and GCSE AS 401. Media/GBR bearer 431 is represented by a bold line between UE 403 and Media GW 402. The MBMS broadcast bearer is a bearer that transmits DL communication from Media GW 402 to Broadcast-Multicast Service Center (BMSC) 440, then to MBMS GW 450, then to evolved Node Bs 460, and then to UEs via point-to-point (PTP) or point-to-multipoint (PTM) radio links. Next, talking UE 403 can initiate communication in UL to transmit communication to GCSE AS/Media Gateway (401 and 402). GCSE AS/Media GW (401 and 402) can receive the UL packets from talking UE 403, and then GCSE AS/Media GW (401 and 402) transmits the packets in DL along with the received or negotiated source identifier (identifying UE 403 as the source) to the group UEs (403-405). In one embodiment, UE 403 is then able to recognize its own source identifier received in in the DL packets. Thus, talking UE 403 is able to either (1) ignore its own DL packets (thus allowing the user of talking UE 403 to not hear the user's own voice in the speaker), or (2) listen to its own voice. All the other group UEs (404 and 405) will not ignore the received packets originating from talking UE 403. Therefore, all the other group UEs (404 and 405) will hear the group communication originating from talking UE 403. In one embodiment, talking UE 403 has an option to not include source identification in the UL packet(s) to CGSE AS 401. In one embodiment, the group communication can also comprise communication originating from one or more of the other UEs (404 and 405) of the group.

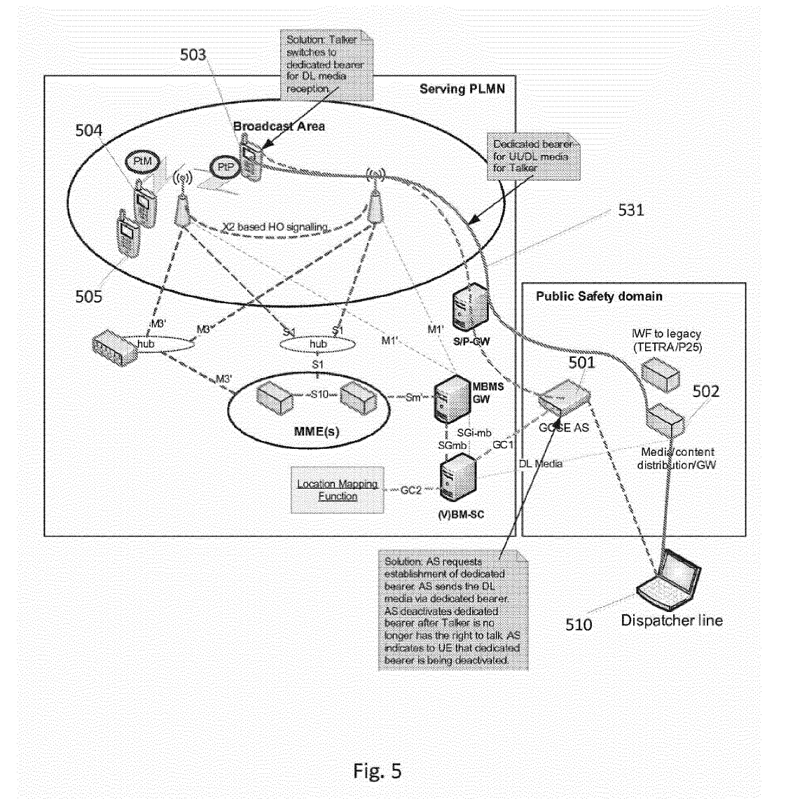

FIG. 5 illustrates an MBMS broadcast in accordance with another embodiment. In this embodiment, talking UE 503 and a network can agree to use a point-to-point communication bearer for DL transmission of communication packets, upon establishment of a dedicated guaranteed bitrate (GBR) bearer for UL transmission of communication packets. Talking UE 503 can ignore DL packets received (from the GCSE AS/Media GW (501 and 502)) via the point-to-point or a point-to-multipoint communication bearer. This embodiment can be applicable to all types of data/media upon establishment of a dedicated GBR bearer for UL.

In one embodiment, GCSE AS 501 establishes a dedicated bearer for talking UE 503 once talking UE 503 is granted “talker rights” via application layer signaling. Application layer signaling is represented in FIG. 5 by a dotted line between UE 503 and GCSE AS 501. Dedicated GBR 531 is represented by a bold line between UE 503, a S/P-GW, and Media GW 502. The GCSE AS 501/Media GW 502 can send DL packets directed to talking UE 503 via the dedicated GBR bearer. Therefore, while the dedicated GBR bearer is established, talking UE 503 uses the dedicated GBR bearer for both UL and DL communication. In contrast, GCSE AS 501/Media GW 502 transmits group communication via the DL to other UEs (504 and 505) using a DL MBMS bearer that is different and separate from the dedicated GBR bearer. The group communication transmitted by GCSE AS 501/Media GW 502 to other UEs (504 and 505) via the DL MBMS bearer is different than the communication transmitted by GCSE AS 501/Media GW 502 to talking UE 503 via the dedicated GBR bearer. Specifically, in one embodiment, the group communication transmitted by the GCSE AS 501/Media GW 502 via the DL MBMS bearer includes communication originating from talking UE 503, while the communication transmitted by GCSE AS 501/Media GW 502 via the dedicated GBR bearer does not include communication originating from talking UE 503.

In one embodiment, GCSE AS 501 can deactivate the dedicated bearer when (1) all or substantially all the packets with a source that corresponds to talking UE 503 (packets where the source is talking UE 503) have been transmitted on the DL MBMS broadcast bearer, or (2) after a certain duration of time has elapsed. For example, the GCSE AS 501 can deactivate the dedicated bearer after an inactivity timer for this dedicated GBR bearer has expired. In another embodiment, GCSE AS 501 can deactivate dedicated bearers after (1) all or substantially all the packets with a source that corresponds to talking UE 503 (the source is the talker) have been transmitted on the DL MBMS broadcast bearer, and (2) GCSE AS 501 has removed the “talker right” from talking UE 503. GCSE AS 501 may delay the dedicated bearer deactivation after the revoking of the “talker's right” for a certain duration.

Therefore, in one embodiment, when talking UE 503 has “talker rights,” talking UE 503 receives DL communication from GCSE AS 501 via the dedicated GBR bearer. Because talking UE 503 receives DL communication from the dedicated bearer (i.e., communication that does not include communication originating from talking UE 503), talking UE 503 can avoid receiving its own communication/voice.

In one embodiment, this duration can ensure that there has been no activity on the bearer to avoid frequent activation and deactivation of dedicated bearers when talkers change. This duration can also allow UE 503 to receive DL packets from the broadcast channel instead of the dedicated bearer based on internal logic. One embodiment can switch over from a dedicated bearer to a broadcast channel, when detecting silence on the group channel, to allow for a seamless user experience. After the dedicated bearer is deactivated, GCSE AS 501 no longer sends DL packets to talking UE 503 via the dedicated GBR bearer. Instead, after the dedicated bearer is deactivated, GCSE AS 501 then sends DL packets to talking UE 503 via the DL MBMS broadcast bearer.

As such, in one embodiment, once UE 503 has been granted talker rights and a dedicated bearer is established, UE 503 recognizes DL packets over the dedicated bearer and ignores packets over the broadcast channel. UE 503 can inform the GCSE AS 501 that its talking has completed. UE 503 can receive an indication from GCSE AS 501 that the dedicated bearer needs to be terminated. UE 503 can then decide to receive DL packets via an MBMS broadcast bearer.

In another embodiment, UE 503 requests GCSE AS 501 for the floor (i.e., to become a talker). Talker UE 503 can initiate a session request to GCSE AS 501 to establish bearers for the UL. A GBR bearer can be established between talker UE 503 and GCSE AS/Media GW (501 and 502). Similar to IP Multimedia System (IMS) Voice-over-LTE (VoLTE), the GCSE AS can use a receiving interface to establish dedicated bearers. GCSE AS 501 grants talker rights to talking UE 503. Talking UE 503 switches to a dedicated GBR bearer for both DL and UL traffic. Talking UE 503 can ignore the DL packets received over the MBMS broadcast bearer. This allows UE 503 to avoid media feedback due to packet delay. If dispatcher 510 interjects itself into the conversation, talking UE 503 will hear the dispatcher's speech via the DL dedicated bearer. At some point in time, dispatcher 510 may drop out of the communication loop to allow the talking UE's speech to continue to other group UEs. Later, GCSE AS 501 can remove talker rights from talking UE 503. GCSE AS 501 can release the resources dedicated to talker UE 503 after all the packets from this source (talking UE 503) have been transmitted on the DL MBMS broadcast bearer. Deactivation of the dedicated GBR bearer is indicated to talking UE 503. GCSE AS 501 may delay the dedicated bearer's deactivation for a certain time after the revoking of the “talker's rights,” as described above.

Once talking UE 503 receives an indication from GCSE AS 501 that the dedicated bearer is to be terminated, or once this bearer is actually terminated, talking UE 503 receives communication again over the MBMS broadcast bearer.

In view of the above, one embodiment of the present invention allows a talking UE to avoid hearing the talking UE's own voice. Certain embodiments provide a scalable solution that can be used by UE, GCSE AS, and media gateways for multiple use cases. Certain embodiments also work for other protocols, such as Message Session Relay Protocol (MSRP). One embodiment provides a negotiated source identifier that ensures that each possible talking UE has a unique identifier. One embodiment can accommodate both: (1) a talking UE that prefers to receive its own packets (for recording purposes, for example) and (2) a talking UE that does not want to receive its own packets.

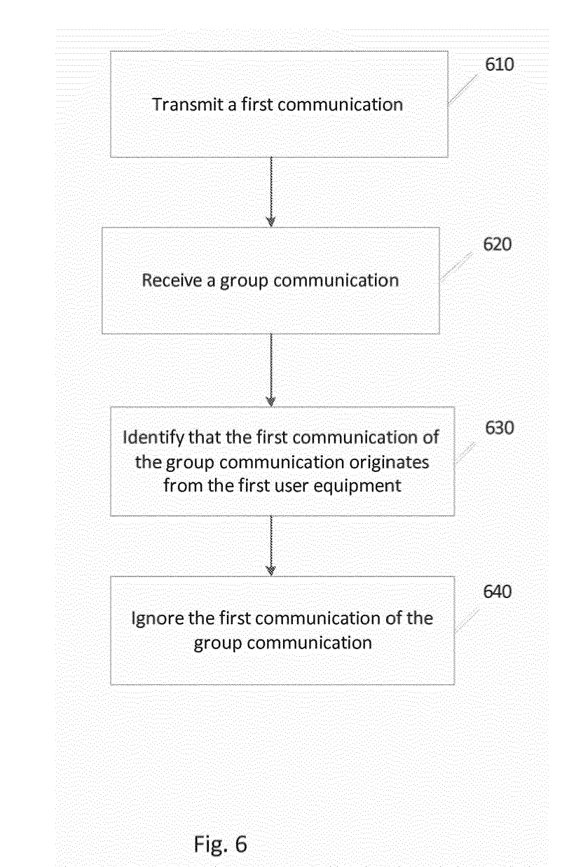

FIG. 6 illustrates a logic flow diagram of a method according to an embodiment. The method illustrated in FIG. 6 includes, at 610, transmitting, by a first user equipment, a first communication. At 620, one embodiment receives, by the first user equipment, a group communication. The group communication is directed to a group. The group comprises the first user equipment and a second user equipment. The group communication comprises the first communication. The group communication also comprises an identifier that identifies the first communication of the group communication as originating from the first user equipment. At 630, one embodiment identifies, by the first user equipment, that the first communication of the group communication originates from the first user equipment based on the identifier. At 640, one embodiment ignores the first communication of the group communication.

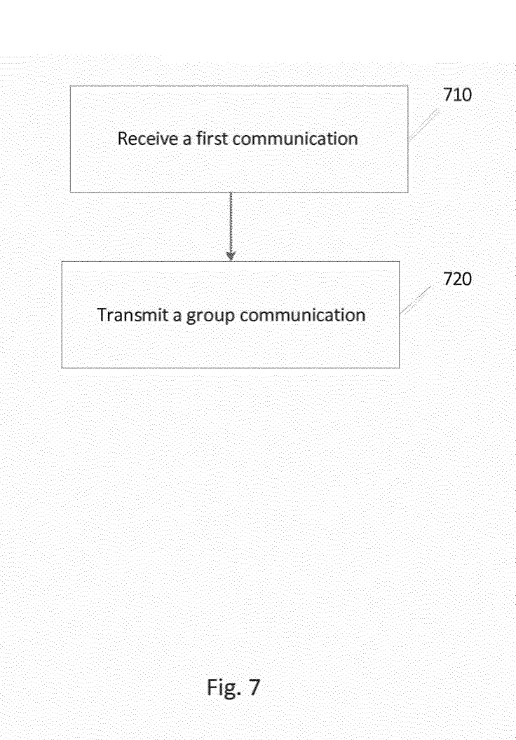

FIG. 7 illustrates a logic flow diagram of a method according to another embodiment. At 710, one embodiment receives a first communication. The first communication originates from a first user equipment. At 720, one embodiment transmits a group communication. The group communication is directed to a group. The group comprises the first user equipment and a second user equipment. The group communication comprises the first communication and an identifier that identifies the first communication of the group communication as originating from the first user equipment.

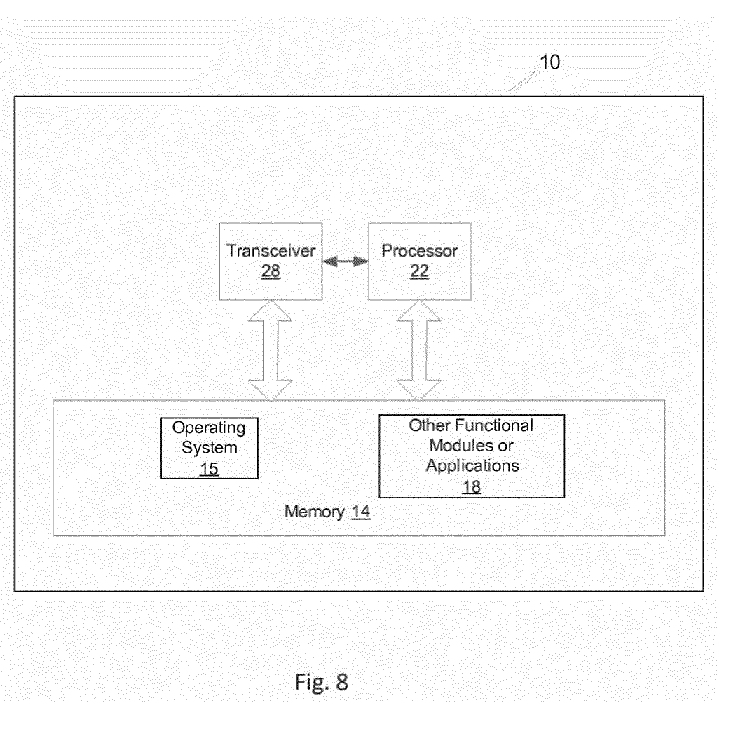

FIG. 8 illustrates an apparatus 10 according to another embodiment. In an embodiment, apparatus 10 can be a device, such as a UE, for example. In another embodiment, apparatus 10 can be a device, such as an application server or a gateway.

Apparatus 10 can include a processor 22 for processing information and executing instructions or operations. Processor 22 can be any type of general or specific purpose processor. While a single processor 22 is shown in FIG. 8, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

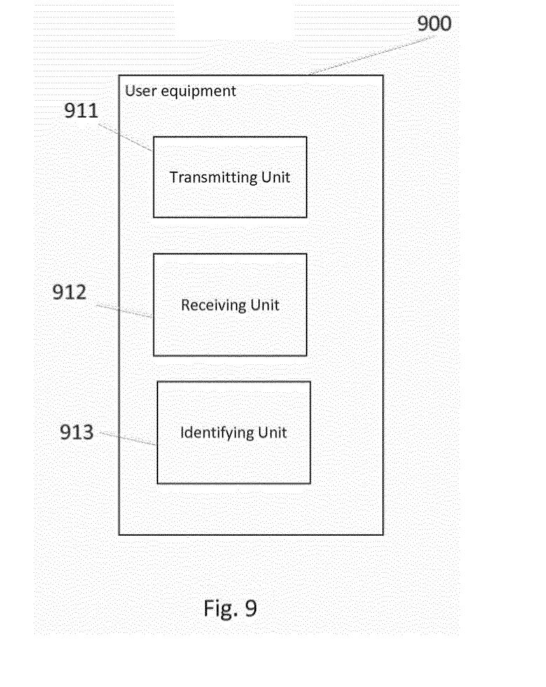

FIG. 9 illustrates an apparatus 900 according to another embodiment. In an embodiment, apparatus 900 can be a user equipment. Apparatus 900 can include a transmitting unit 911 that transmits, by a first user equipment, a first communication. Apparatus 900 can also include a receiving unit 912 that receives, by the first user equipment, a group communication. The group communication can be directed to a group. The group comprises the first user equipment and a second user equipment. The group communication comprises the first communication. The group communication also comprising an identifier that identifies the first communication of the group communication as originating from the first user equipment. Apparatus 900 can also include an identifying unit 913 that identifies that the first communication of the group communication originates from the first user equipment based on the identifier. Apparatus 900 also ignores the first communication of the group communication.

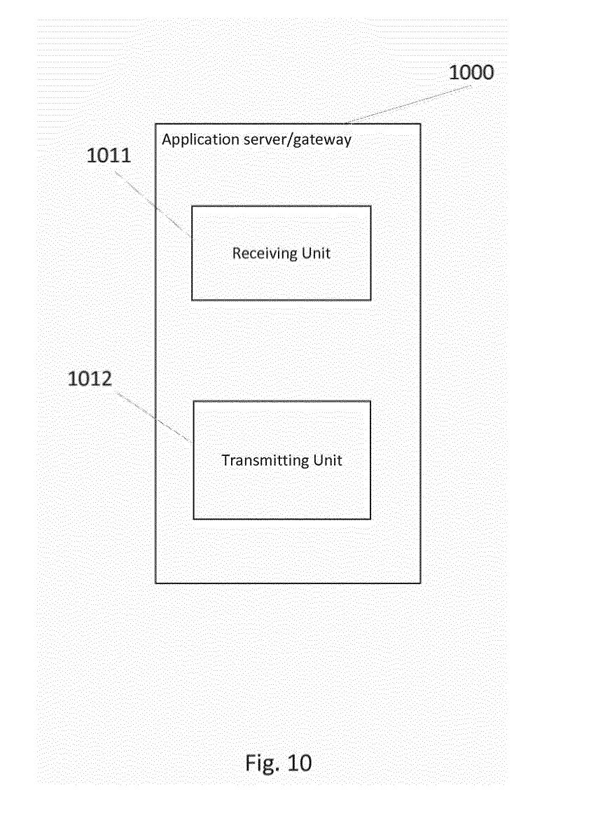

FIG. 10 illustrates an apparatus 1000 according to another embodiment. In an embodiment, apparatus 1000 can be at least one of an application server or a gateway.

Apparatus 1000 can include receiving unit 1011 that receives a first communication. The first communication originates from a first user equipment. Apparatus 1000 can also include a transmitting unit 1012 that transmits a group communication. The group communication can be directed to a group. The group comprises the first user equipment and a second user equipment. The group communication comprises the first communication and an identifier that identifies the first communication of the group communication as originating from the first user equipment.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
transmitting, by a first user equipment, a first communication;
receiving, by the first user equipment, a group communication, wherein the group communication is directed to a group, the group comprises the first user equipment and a second user equipment, the group communication comprises the first communication, and the group communication also comprises an identifier that identifies the first communication of the group communication as originating from the first user equipment;
identifying, by the first user equipment, that the first communication of the group communication originates from the first user equipment based on the identifier; and
ignoring the first communication of the group communication.

2. The method according to claim 1, wherein the group communication also comprises a second communication, and the second communication originates from the second user equipment.

3. The method according to claim 1, wherein the identifier corresponds to an internet protocol address of the first user equipment.

4. The method according to claim 1, wherein the group communication is delivered using Real Time Protocol, and the identifier is delivered in a Synchronization Source Identifier field.

5. The method according to claim 1, wherein the group communication is delivered using Real Time Protocol, and the identifier is delivered in an optional header extension field.

6. The method according to claim 1, wherein the identifier corresponds to a negotiated identifier, and the negotiated identifier is the result of negotiations between the first user equipment and at least one of an application server and a gateway.

7. An apparatus, comprising:
at least one processor; and
at least one memory including computer program code,
the at least one memory and the computer program code configured, with the at least one processor, to cause the apparatus at least to
transmit, by a first user equipment, a first communication;
receive, by the first user equipment, a group communication, wherein the group communication is directed a group, the group comprises the first user equipment and a second user equipment, the group communication comprises the first communication, and the group communication also comprises an identifier that identifies the first communication of the group communication as originating from the first user equipment;
identify, by the first user equipment, that the first communication of the group communication originates from the first user equipment based on the identifier; and
ignore the first communication of the group communication.

8. The apparatus according to claim 7, wherein the group communication also comprises a second communication, and the second communication originates from the second user equipment.

9. The apparatus according to claim 7, wherein the identifier corresponds to an internet protocol address of the first user equipment.

10. The apparatus according to claim 7, wherein the group communication is delivered using Real Time Protocol, and the identifier is delivered in a Synchronization Source identifier field.

11. The apparatus according to claim 7, wherein the group communication is delivered using Real Time Protocol, and the identifier is delivered in an optional header extension field.

12. The apparatus according to claim 7, wherein the identifier corresponds to a negotiated identifier, and the negotiated identifier is the result of negotiations between the first user equipment and at least one of an application server and a gateway.

13. A computer program product, embodied on a computer readable medium, the computer program product configured to control a processor to perform a process, comprising:
transmitting, by a first user equipment, a first communication;
receiving, by the first user equipment, a group communication, wherein the group communication is directed a group, the group comprises the first user equipment and a second user equipment, the group communication comprises the first communication, and the group communication also comprises an identifier that identifies the first communication of the group communication as originating from the first user equipment;
identifying, by the first user equipment, that the first communication of the group communication originates from the first user equipment based on the identifier; and
ignoring the first communication of the group communication.

14. A method, comprising:
receiving a first communication, wherein the first communication originates from a first user equipment; and
transmitting a group communication, wherein the group communication is directed to a group, the group comprises the first user equipment and a second user equipment, the group communication comprises the first communication and an identifier that identifies the first communication of the group communication as originating from the first user equipment.

15. The method according to claim 14, wherein the receiving and the transmitting are performed by at least one of an application server and a gateway.

16. The method according to claim 14, wherein the group communication also comprises a second communication, and the second communication originates from the second user equipment.

17. The method according to claim 14, wherein the identifier corresponds to an internet protocol address of the first user equipment.

18. The method according to claim 14, wherein the group communication is delivered using Real Time Protocol, and the identifier is delivered in a Synchronization Source identifier field.

19. The apparatus according to claim 14, wherein the group communication is delivered using Real Time Protocol, and the identifier is delivered in an optional header extension field.

20. An apparatus, comprising:
at least one processor; and
at least one memory including computer program code,
the at least one memory and the computer program code configured, with the at least one processor, to cause the apparatus at least to
receive a first communication, wherein the first communication originates from a first user equipment; and
transmit a group communication, wherein the group communication is directed to a group, the group comprises the first user equipment and a second user equipment, the group communication comprises the first communication and an identifier that identifies the first communication of the group communication as originating from the first user equipment.

21. The apparatus according to claim 20, wherein the receiving and the transmitting are performed by at least one of an application server and a gateway.

22. The apparatus according to claim 20, wherein the group communication also comprises a second communication, and the second communication originates from the second user equipment.

23. The apparatus according to claim 20, wherein the identifier corresponds to an internet protocol address of the first user equipment.

24. The apparatus according to claim 20, wherein the group communication is delivered using Real Time Protocol, and the identifier is delivered in a Synchronization Source identifier field.

25. The apparatus according to claim 20, wherein the group communication is delivered using Real Time Protocol, and the identifier is delivered in an optional header extension field.

26. A computer program product, embodied on a computer readable medium, the computer program product configured to control a processor to perform a process, comprising:
receiving a first communication, wherein the first communication originates from a first user equipment; and
transmitting a group communication, wherein the group communication is directed to a group, the group comprises the first user equipment and a second user equipment, the group communication comprises the first communication and an identifier that identifies the first communication of the group communication as originating from the first user equipment.

27. A method, comprising:
transmitting, by a first user equipment, a first communication via a dedicated bearer, wherein the dedicated bearer is established once the first user equipment is authorized to transmit the first communication, the first communication is included in a first group communication, the first group communication is directed to a group via a broadcast bearer, the group comprises the first user equipment and a second user equipment, and the group communication also comprises a second communication transmitted by the second user equipment;
receiving, by the first user equipment, a second group communication via the dedicated bearer, wherein the second group communication comprises the second communication, the second group communication does not include the first communication, the first user equipment ignores the first group communication directed to the group via the broadcast bearer while the dedicated bearer is established, and the dedicated bearer is deactivated after the broadcast bearer has transmitted all of the first communication of the first group communication to the second user equipment; and
receiving, by the first user equipment, the first group communication via the separate broadcast bearer once the dedicated bearer is deactivated.

28. A method, comprising:
receiving a first communication via a dedicated bearer, wherein the dedicated bearer is established once a first user equipment is authorized to transmit the first communication;
transmitting a first group communication via a separate broadcast bearer, wherein the first group communication is directed to a group, the group comprises the first user equipment and a second user equipment, the first group communication comprises the first communication, and the group communication also comprises a second communication transmitted by a second user equipment;
transmitting a second group communication via the dedicated bearer, wherein the second group communication comprises the second communication, the second group communication does not include the first communication, and the dedicated bearer is deactivated after the separate broadcast bearer has transmitted all of the first communication of the first group communication to the second user equipment.
